(19) United States
(12) Patent Application Publication
(10) Pub. No.: US 2005/0095897 A1
(43) Pub. Date: May 5, 2005

(54) Electrical connector having reliable terminal

(75) Inventor: Hsiu-Yuan Hsu, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 10/973,569

(22) Filed: Oct. 25, 2004

(30) Foreign Application Priority Data
Oct. 31, 2003 (TW) 92219409

(51) Int. Cl. H01R 13/625

(52) U.S. Cl. 439/342

(57) ABSTRACT

A terminal for an electrical connector includes a base portion (30), a soldering portion (36) extending from a bottom end of the retaining portion, and a pair of arm portions (33). Each arm portion includes an upper arm (32) extending obliquely downwardly from a lateral side of the base portion, a forearm (34) extending upwardly from a free end of the upper arm, a clamp (40) at an upper end of the forearm, and a palm (44) extending obliquely from the clamp toward the base portion. A clamping space (42) is defined between the palms for clamping a pin of a CPU. A free space (45) is defined between the clamps for guiding the pin of the CPU inserting into the clamping space in a predetermined inserting direction. The clamps offset a certain angle with respect to the direction.

### BACKGROUND OF THE INVENTION

1. Field of the invention

The present invention relates to an electrical connector, and particularly to an electrical connector having a plurality of reliable terminals for electrically connecting an electronic package such as a central processing unit (CPU) with a circuit substrate such as a printed circuit board (PCB).

2. Description of the prior art

Electrical connectors are widely used in electrically connecting electronic packages such as central processing units (CPUs) with circuit substrates such as printed circuit boards (PCBs). Patented examples of such electrical connectors are disclosed in U.S. Pat. Nos. 4,498,725 and 6,267,615.

Referring to FIGS. 5 to 7, a conventional electrical terminal 9 for an electrical connector electrically connecting a CPU (not shown) with a PCB (not shown) comprises a base portion 91, a soldering portion 92 extending from a bottom end of the base portion 91, and a pair of arm portions 93 connected to the base portion 91. The soldering portion 92 electrically connects with the PCB via a solder ball (not shown). Each arm portion 93 includes an upper arm 931 extending obliquely downwardly from a lateral side of the base portion 91 toward the soldering portion 92, a forearm 932 extending upwardly from a free end of the upper arm 931, a clamp 933 at an upper end of the forearm 932, and a palm 95 extending obliquely from the clamp 933 toward the base portion 91. A clamping space 934 is defined between the clamps 933 for clamping a pin 99 of the CPU therein. A free space 951 is defined between the palms 95 for guiding the pin 99 inserting into the clamping space 934 in a predetermined direction A (seen in FIGS. 6 and 7). The clamp 933 is parallel to the direction A.

Referring to FIGS. 6 and 7, when the CPU engages with the connector, the pin 99 of the CPU firstly enters into the free space 951 between the two palms 95, at this time, the pin 99 contacts the inner face of the palm 95. The pin 99 is then moved in direction A from the free space 951 toward the clamping space 934 by conventional operating force. The pin 99 is subsequently clamped between the clamps 933. The pin 99 is thus resiliently and firmly electrically connected with the terminal 9 of the connector.

However, when the pin 99 moves from the free space 951 into the clamping space 934, a part of the clamp 933 will be received a force so that the two clamps 933 offset outward a certain angle θ related to the direction A (best seen in FIG. 7). When the pin 99 moves out from the clamping space 934, the clamp 933 will apply a supporting force N, a friction F′ perpendicular to the force N on the pin 99. A force F is applied on the pin 99 for separating the pin 99 from the clamps 933 of the terminal 9. Because the clamps 933 offset the angle θ, and the force F=2(N Sin θ+F′ Cos θ), the force F will be increased. Thus the increased force F will make it difficult to disengage the pin 99 from the terminal 9.

In view of the above, a new electrical connector that overcomes the above-mentioned disadvantages is desired.

### SUMMARY OF THE INVENTION

Accordingly, an object of the present invention is to provide an electrical connector that has a plurality of electrical terminals reliably electrically connecting an electronic package such as a central processing unit (CPU) with a circuit substrate such as a printed circuit board (PCB).

Another object of the present invention is to provide an electrical connector having a plurality of terminals that are configured to reduce force required to move a pin of the CPU from a free space of the terminal into a clamping space of the terminal.

To fulfill the above-mentioned objects, an electrical connector in accordance with a preferred embodiment of the present invention comprises an insulative base, a cover mounted on the base, and a plurality of terminals received in the base. The base defines an array of a multiplicity of passageways therethrough, for receiving a corresponding number of the terminals therein. Each terminal comprises a base portion, a soldering portion extending from a bottom end of the base portion for soldering to a PCB via a solder ball, and a pair of arm portions connected to the base portion. Each arm portion comprises an upper arm extending obliquely downwardly from a lateral side of the base portion, a forearm extending upwardly from a free end of the upper arm, a clamp at an upper end of the forearm, and a palm extending obliquely from the clamp toward the base portion. A clamping space is defined between the clamps for clamping a pin of a CPU. A free space is defined between the palms for guiding the pin of the CPU inserting into the clamping space in a predetermined inserting direction. The clamps offset a certain angle with respect to the direction. When the pin of the CPU disengages with the terminal, the clamps with offsetting the certain angle respective can give a force on the pin along an opposite direction to the inserting direction, and the pin of the CPU therefore easily disengages from the clamps of the terminal.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of an electrical connector in accordance with the preferred embodiment of the present invention, only showing one terminal;

FIG. 2 is an isometric view of the terminal of FIG. 1;

FIG. 3 is a schematic, top plan view of the terminal in accordance with the preferred embodiment of the present invention, showing a pin of a CPU above the terminal ready to be connected with the terminal;

FIG. 4 is similar to FIG. 3, but showing the pin of the CPU connected with the terminal;

FIG. 5 is an isometric view of an electrical terminal of a conventional electrical connector;

FIG. 6 is a schematic, top plan view of said conventional terminal, showing a pin of a CPU above the terminal ready to be connected with the terminal; and

FIG. 7 is similar to FIG. 6, but showing the pin of the CPU connected with the terminal.

### DETAILED DESCRIPTION OF THE PREFERRED EMBODIMENT OF THE INVENTION

Reference will now be made to the drawings to describe the present invention in detail.

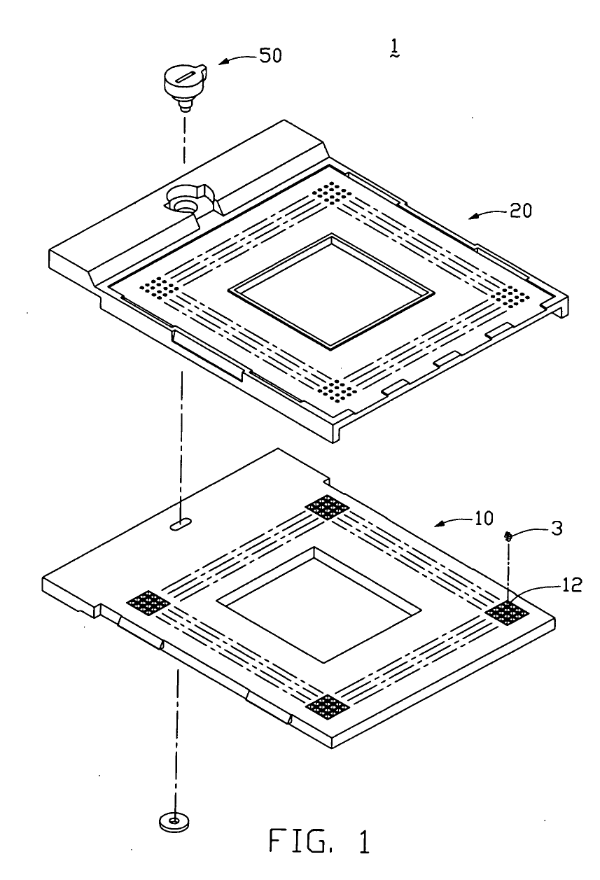

Referring to FIG. 1, an electrical connector 1 in accordance with a preferred embodiment of the present invention is used for electrically connecting an electronic package such as a central processing unit (CPU) (not shown) with a circuit substrate such as a printed circuit board (PCB) (not shown). The connector 1 comprises an insulative base 10, a cover 20 mounted on the base 10, an actuator 50 received between the base 10 and the cover 20, and a plurality of terminals 3 received in the base 10. The base 10 defines an array of a multiplicity of passageways 12 therethrough, for receiving a corresponding number of the terminals 3 therein.

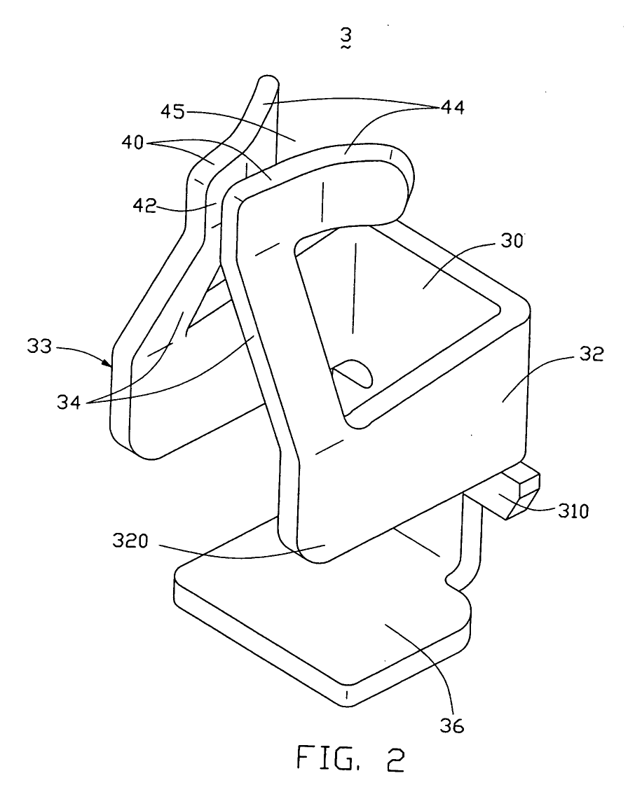

Referring to FIGS. 1 and 2, each terminal 3 comprises a base portion 30, a soldering portion 36 extending perpendicularly from a bottom end of the base portion 30, and a pair of arm portions 33 extending slantingly from two lateral ends of the base portion 30. A pair of barbs 310 is respectively formed at bottom portions of the opposite lateral edges of the base portion 30, for interferentially securing the terminal 3 in a corresponding passageway 12 of the connector 1.

Each arm portion 33 extends upwardly in a vertical direction higher than a height of the base portion 30 and includes an upper(rear) arm 32 extending obliquely downwardly from the lateral end toward the soldering portion 36, an elbow 320 at a bottom portion of the upper arm 32, a forearm 34 extending upwardly from the elbow 320, and a clamp 40 at a top portion of the forearm 34, and a palm 44 extending obliquely smoothly from a distal end of the clamp 40 toward the base portion 30 and being directly above the base portion 30. The forearms 34 of the two arm portions 33 are inclined inwardly toward each other, and the palms 44 of the two arm portions 33 are inclined outwardly away from each other. A clamping space 42 is formed between the clamps 40, for clamping the pin 4 of the CPU therein, and a free space 45 is formed between the palms 44, for guiding the pin 4 of the CPU to insert into the clamping space 42. An engaging direction B (see FIG. 2) is defined perpendicular to the base portion 30, such that the pin 4 of the CPU moves from the free space 45 to the clamping space 42 along direction B during engagement of the pin 4 with the terminal 3. The clamp 40 offsets an acute angle θ1 (θ1>0) with the direction B.

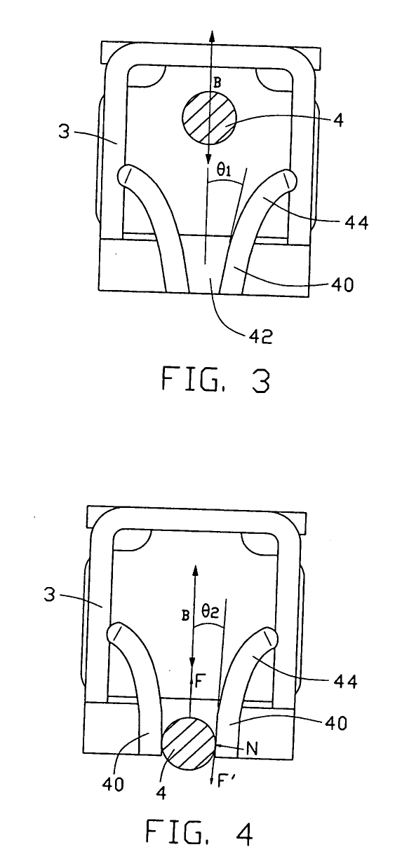

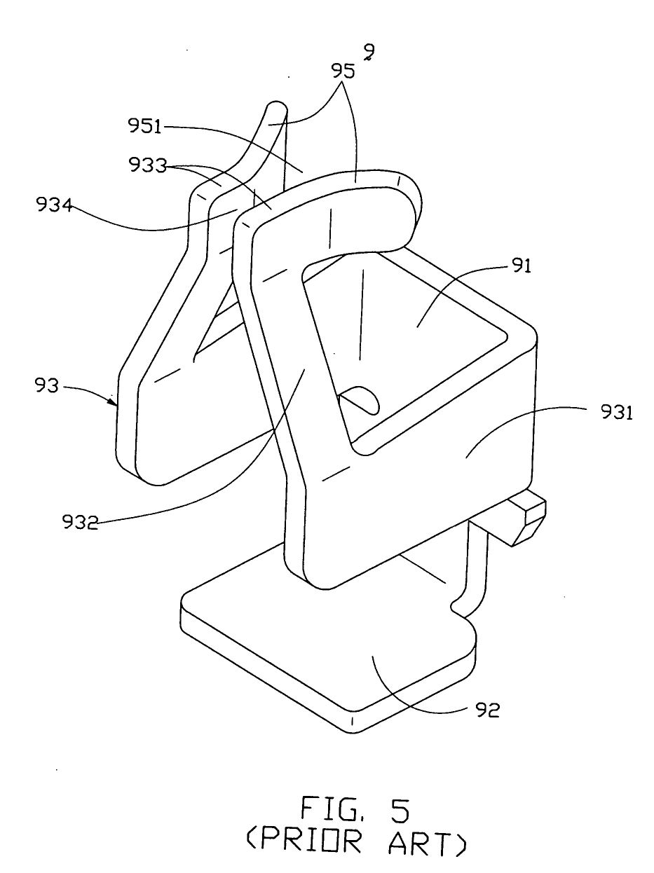

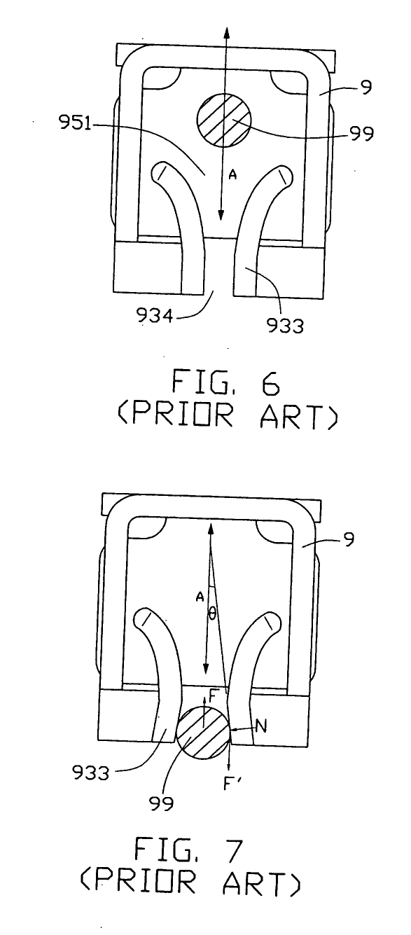

Referring to FIGS. 3 and 4, when the pin 4 is vertically inserted into the free space 45 between the two palms 44, the pin 4 firstly contacts a corresponding portions of the palms 44. The pin 4 is then moved in direction B from the free space 45 toward the clamping space 42 by rotating the actuator 50 from an open position to a closed position, the pin 4 will be clamped in the clamping space 42 by the two clamps 40. Thus reliable electrical connection between the CPU and the connector 1 is obtained.

In the above-described engagement process, the pin 4 make the clamps 40 move away from each other relative to the direction B. Because the clamp 40 offsets the angle θ1 with the direction B in the beginning, after the pin 4 clamped in the clamping space 42, the clamp 40 offseting a certain angle θ2 (θ2≧0) relative to the direction B is smaller than that of the conventional terminal 9. When the pin 4 moves outward from the clamping space 42, the clamp 40 will apply a supporting force N, a friction F′ perpendicular to the force N on the pin 4. A force F is applied on the pin 4 for separating the pin 4 from the clamps 40 of the terminal 3. Because the clamps 40 offset a smaller angle θ2, and the force F=2(F′ Cos θ2−N sin θ2), the force F will be decreased than that of the conventional terminal 9. Thus, the pin 4 and the terminal 3 are reliably protected.

It can be noted that the clamp 40 is located at an upper end of the forearm 34 and experienced with both a first rotative displacement in a vertical plane due to deflection of said forearm 34 and a second rotative displacement in a horizontal plane due to deflection of said rear arm 32, when a pin 4 is moved, in a horizontal direction, from the palm 44 to the clamp 40 and eventually is located in an engagement position to urge and electrically and mechanically engage the clamp 40. The oblique arrangement of the clamp 40 is essentially to counterbalance the second rotative displacement.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector for connecting an electronic package with a circuit substrate, the electrical connector comprising:
a base defining a plurality of passageways therethrough;
a cover mounted on the base; and
a plurality of terminals received in the passageways respectively, each terminal comprising a base portion engagingly received in a corresponding passageway of the base, a soldering portion extending from the base portion, a pair of arm portions extending from opposite lateral ends of the base portion in a first horizontal direction, each arm portion having an upper arm extending slantingly outwardly from the end of the base portion, a forearm connecting one end of the upper arm, a clamp extending from an upper end of the forearm for clamping a pin of the electronic package, and a palm extending obliquely smoothly from an end of the clamp toward the base portion in a second horizontal direction opposite to the first horizontal direction; a clamping space formed between the clamps, a free space formed between the palms, wherein the clamp is offset an acute angle relative to a direction where the pin inserts from the free space into the clamping space.

2. The electrical connector as claimed in claim 1, wherein the arm portion extend upwardly in a vertical direction higher than the base portion.

3. The electrical connector as claimed in claim 1, wherein the base portion forms a pair of barbs at two lateral ends thereof for interferentially engaging with a corresponding passageway of the base.

4. The electrical connector as claimed in claim 1, wherein the connector further comprises an actuator received between the base and the cover.

5. An electrical connector assembly comprising:
an insulative housing defining a plurality of passageways therein;
a plurality of terminals disposed in the corresponding passageways, respectively; p1 a plurality of pin type conductors inserted into the corresponding passageways to electrically and mechanically engage the corresponding terminals, respectively;
each of said terminals defining at least one clamping section and a palm section extending from the clamping section generally horizontally and outwardly so as to allow the corresponding pin type conductor to be initially downwardly inserted into the corresponding passageway around the palm section in a zero-insertion-force manner and successively to move, in a first horizontal direction, toward and engage the corresponding clamping section; wherein
said clamping section extends in a first oblique direction toward said palm section with thereof a first acute angle relative to said first horizontal direction from a top view of the housing, and applies a force against the corresponding pin type conductor when said corresponding pin type conductor is located in a final engagement position with regard to the corresponding terminal so as to result in a force component helping said pin type conductor move in a second horizontal direction opposite to said first horizontal direction when said corresponding pin type conductor is intended to be disengaged from the corresponding terminal.

6. The connector as claimed in claim 5, wherein there are a pair of clamping sections associated with a pair of palm sections to engage the corresponding pin type conductor.

7. The connector as claimed in claim 5, wherein said terminal includes a forearm downwardly connected below the clamping section and a rear arm connected to the forearm via an elbow located around a bottom end of the forearm, and wherein said rear arm extends at least along said second direction and terminates at a base portion.

8. The connector as claimed in claim 5, wherein when said pin type conductor is disengaged from the corresponding terminal, said clamping section extends in a second oblique direction toward said palm section with thereof a second acute angle relative to said first horizontal direction from the top view of the housing, and wherein said second acute angle is smaller than said first acute angle.

9. The connector as claimed in claim 7, wherein said base portion includes retention devices to retain the corresponding terminal to the housing.

10. The connector as claimed in claim 7, wherein said forearm extends from the elbow to the clamping section both upwardly and inward while said palm section extends from the clamping section both horizontally and outwardly.

11. An electrical connector assembly comprising:
an insulative housing defining a plurality of passageways;
a plurality of terminals disposed in the corresponding passageways, respectively, each of said terminals defining a base portion with a rear arm extending thereform, and a forearm connected to said rear arm via an elbow, and
a clamping section located at an upper end of the forearm and experienced with both a first displacement in a vertical plane due to deflection of said forearm and a second displacement in a horizontal plane due to deflection of said rear arm, when a pin type conductor is moved, in a horizontal direction, from the palm section to the clamping section and eventually is located in an engagement position to urge and electrically and mechanically engage said clamping section; wherein
said clamping section extends obliquely toward the corresponding palm section relative to said horizontal direction from a top view of the housing, regardless of whether or not the pin type conductor is inserted into the passageway and engaged with the corresponding terminal.
